(19) United States
(12) Patent Application Publication
(10) Pub. No.: US 2026/0087443 A1
(43) Pub. Date: Mar. 26, 2026

(54) METHOD TO CREATE AND DELIVER SURPRISE ORDER

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/897,400

(22) Filed: Sep. 26, 2024

(51) Int. Cl. G06Q 10/0832; G06Q 30/0601; H04W 4/029

(52) U.S. Cl. CPC G06Q 10/0832; H04W 4/029; G06Q 30/0641

(57) ABSTRACT

A method performed by a server computer system enables discreet delivery of an acquired item to a delivery address. The method includes providing, within an online transaction portal, an option enabling selection of discreet delivery, which avoids delivery of the item to a specific person having an electronic device that is location-trackable via a first electronic device registered to communicate a trigger/message to facilitate discreet delivery of the item. The method includes receiving and storing identifying information of the first electronic device. The method includes, in response to subsequently receiving the trigger/message from the first electronic device indicating a delivery/exclusion time window for delivering the item to the destination, generating and transmitting a notification to a delivery provider device, the notification triggering the delivery provider device to output the delivery/exclusion time window and alerting a delivery provider to complete delivery of the item based on the provided delivery/exclusion time window.

### BACKGROUND

### 1. Technical Field

The present disclosure generally relates to electronic devices that support online commerce, and more specifically to electronic devices that support online commerce with special delivery instructions.

### 2. Description of the Related Art

E-commerce services offer unprecedented convenience for shoppers seeking to purchase/acquire goods spanning categories from fashion to appliances, from home décor to books, et.al. An important aspect of these online ecommerce transactions is the shipment/delivery of the purchased/acquired item to a recipient address. Online shoppers typically enter a destination/delivery address and select a type of delivery/shipment desired. The delivery of the purchased/acquired items then occurs based on the selected type of shipment/delivery, and the item is either handed to whomever is present at the delivery location or left outside the front door or at another location at the delivery address.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of a server computer system within an e-commerce environment, with specific server components that enable the server computer system to implement discreet delivery of online purchases, based on communications with communicatively-connected user devices, according to one or more embodiments;

FIG. 2 depicts example component makeup of a first user device operative to implement user device features for discreet delivery of online purchases within the e-commerce environment of FIG. 1, according to one or more embodiments;

FIG. 3A illustrates an exemplary user interface for interacting with the e-commerce server to complete an e-commerce transaction and initiate/select discreet delivery of the purchased item(s), according to one or more embodiments;

FIG. 3B illustrates a second exemplary user interface that presents the person completing the purchase of the item in FIG. 3A with server-side options for discreet delivery set-up for the purchased item, according to one or more embodiments;

FIG. 4A illustrates an exemplary local user interface of the first user device to establish local-device-side delivery parameters, including inclusions/exclusions of selected group member(s) to enable discreet delivery of an online purchase, according to one or more embodiments;

FIG. 4B illustrates a second exemplary user interface for a user of the first user device to selectively establish delivery rules based on presence/absence of specific group members at a delivery location and enable discreet delivery of a purchased/acquired item, according to one or more embodiments;

FIGS. 5A-5D depict example scenarios for determining whether to trigger completion of a surprise delivery based on locations of multiple users within a group space relative to a home delivery location, according to one or more embodiments;

FIG. 6A illustrates an exemplary notification user interface for the first user device based on an un-scheduled change in a condition at a delivery location that can require an interruption of or modification to a delivery schedule due to presence or absence of at least one person within the group, according to one or more embodiments.

FIG. 6B illustrates an exemplary user interface for a user of the first user device to implement/set an updated delivery schedule in response to the changed condition of FIG. 6A, according to one or more embodiments;

FIGS. 7A-7B (collectively FIG. 7) depict a flowchart of a computer-implemented method at an e-commerce server for discreet delivery of online purchases, according to one or more embodiments; and

FIG. 8 depicts a flowchart of another computer-implemented method at a user device for implementing discreet delivery of online purchases, according to one or more embodiments.

### DETAILED DESCRIPTION

According to aspects of the present disclosure, a computer system, an electronic device, a method, and a computer program product provide techniques for facilitating discreet delivery of online purchases to prevent delivery of the purchased item to a restricted person within a group of people having devices that are trackable within a shared group, such as a family group.

According to one aspect, a method performed by a server computer system enables discreet delivery of an acquired item to a delivery address. The method includes providing, within an online transaction portal, an option enabling selection of discreet delivery, which avoids delivery of the item to a specific person having an electronic device that is location-trackable via a first electronic device registered to communicate a trigger/message to facilitate discreet delivery of the item. The method includes receiving and storing identifying information of the first electronic device. The method includes, in response to subsequently receiving the trigger/message from the first electronic device indicating a delivery/exclusion time window for delivering the item to the destination, generating and transmitting a notification to a delivery provider device, the notification triggering the delivery provider device to output the delivery/exclusion time window and alerting a delivery provider to complete delivery of the item based on the provided delivery/exclusion time window.

According to another aspect, a method performed by the first electronic device of a connected group of devices, includes enabling access to an online-accessible item selection portal, the online-accessible item selection portal being configured to enable selection of an item for delivery as a surprise gift for a second user associated with a second electronic device of the connected group, where a delivery setting identifies the item for discreet delivery scheduling that prevents disclosure of the item to the second user. The method includes following completion of selection of the item for delivery via the discreet delivery scheduling, activating a dynamic delivery tracking process that configures the first electronic device to provide messages to a delivery provider of specific time windows or restrictions/exclusions on a time for delivery of the item, which is in part determined based a location of at least the second electronic device relative to the delivery address. The method includes dynamically tracking a location of the second electronic device relative to the delivery address and identifying when the location of the second device is not at or not predicted to be at the destination address during a delivery time window. In some embodiments, the method may include retrieving and evaluating historical location data of the second device to predict a time when the second device will next be at the delivery address. The method includes, in response to the second device being scheduled to be or being away from the destination address for greater than a threshold period of time, generating a delivery time window and communicating the delivery time window to a computer system associated with a shipper or delivery provider to trigger the computer system to schedule delivery of the item based on the delivery time window. The method includes, in response to the second electronic device being at the destination address and determining, from evaluation of the historical data, a likelihood that the item will be received by the second user, generating a delivery exclusion window and communicating the delivery exclusion widow to the computer system to trigger the computer system to withhold/suspend attempts at delivering the items during the delivery exclusion window.

With the wide proliferation of e-commerce, customers frequently shop online for items that are selected for delivery to their home address, which is typically shared by their immediate or extended family or roommate(s), etc. Because of the convenience of online shopping, users frequently will shop online for gifts that are intended to be presented/given as a surprise to another person in the same household (or other shared delivery address). The surprise is intended to occur at a time and setting that is different from the delivery of the item to the home. With current delivery processes, ensuring that an item intended as a surprise (e.g., for later presentation at an upcoming special occasion) is not received or opened prematurely by the gift recipient can be problematic. The aim in delivering a surprise order is to have the item arrive without the knowledge of the intended gift recipient. However, the traditional e-commerce delivery process guarantees delivery, at most, over a range of hours on a given day. Invariably, the person who receives the delivery at the delivery address may be the very person for whom the item is intended to be provided to at a later time, as a surprise. When this situation occurs, the element of surprise is lost and there is a collective disappointment in that the gift loses some, if not all, of its luster, because the gift is no longer a surprise. The described embodiments of the present disclosure present discreet delivery methods that constitute a flexible system of tracking locations of the intended recipient and scheduling the item delivery with built-in scheduling redundancies that all but ensure selected items are delivered to and received at the delivery location without detection by restricted persons (i.e., persons from whom knowledge of the delivery is to be withheld).

According to some embodiments, the computer system includes a communications subsystem that communicatively couples the computer system to (i) at least one first electronic device that monitors location data of at least one second electronic device, the at least one first and at least one second electronic devices being communicatively connected within a device-connected group, the at least one second electronic device including a second user device associated with a second user, and (ii) at least one delivery electronic device associated with a delivery provider. The computer system includes a memory comprising a delivery time/exclusion determining (DTE) module that identifies and indicates, for use by the delivery provider, at least one of a preferred delivery time window and a delivery exclusion window corresponding to when delivery of an item should or should not be attempted at a delivery address, in part based on a corresponding one of delivery time and delivery exclusion data received at the computer system from a first user device among the at least one first device(s). The first user device is linked with discreet delivery of the item and configured to track a known or expected location of the second user device and transmit the delivery data based on a known or expected location of the second user device. The computer system includes a controller communicatively coupled to the communications subsystem and the memory and which executes the DTE module. The controller is configured to cause the computer system to: (i) provide, within a delivery scheduling user interface, a selectable option providing a first delivery setting that enables discreet delivery of the item to be scheduled based on receipt of the delivery data from the first user device in order to avoid delivery of the item outside of a specified delivery time or during a delivery exclusion time identified by the received delivery data. The controller is configured to cause the computer system to: (ii) in response to receiving a selection of the first delivery setting, activate a dynamic delivery process that configures the computing system to alert the delivery provider of specific restrictions on a time for delivery of the item, which is in part determined based on subsequently received delivery data from the first user device; and (iii) in response to subsequently receiving delivery data from the first user device indicating at least one of a delivery time window for delivering the purchased/acquired item to a delivery destination or a delivery exclusion window during which delivery should not be attempted, generate and transmit a delivery notification to the delivery electronic device, the notification triggering the delivery electronic device to provide an alert to the delivery provider to complete the delivery of the item based on the received delivery data.

In one or more embodiments, wherein the acquired item is a purchased item from a retailer, and the controller is configured to cause the computer system to receive selection of the item during a purchase transaction. The controller is configured to receive at least one unique device identifier (ID) associated with the first user device. The controller is configured to associate stored delivery metadata corresponding to the purchase transaction and discreet delivery of the purchased item with the unique ID of the first user device; monitor for received delivery data from the first user device, the received delivery data having metadata with the unique ID that indicates origination from the first user device associated with the purchase transaction and delivery of the purchased item. The controller is configured to apply the received delivery data to generate a corresponding delivery notification that is transmitted to the delivery provider.

In one or more embodiments, the controller is configured to cause the computer system to: receive, as the delivery data from the first user device, first delivery activation data corresponding to a location of the second user device being away from the delivery destination during at least one delivery window; and monitor for subsequent receipt of at least one of: (i) a confirmation of completion of the delivery of the item within the delivery window, the confirmation received from at least one of the third electronic device and the at least one first electronic device; and (ii) second delivery data comprising an interrupt delivery notification from the first electronic device indicating that delivery conditions have changed, requiring an in-progress or pending delivery to be aborted or temporarily suspended. In a particular embodiment, the computer system, in response to receiving the interrupt delivery notification from the first electronic device: generates and transmits an interrupt notification to the third electronic device alerting the delivery provider to abort/suspend completion of the delivery until additional information is provided with a new time window for completing the delivery. In a particular embodiment, the controller is further configured to identify a next delivery window and send notification of an adjusted delivery time window to the third electronic device to trigger completion of the delivery during the identified next delivery window.

According to one or more embodiments, a method provides, within an online transaction portal, a selectable option corresponding to a first delivery setting, enabling an item selected for delivery by a first person to be tagged for special delivery scheduling that avoids delivery of the selected item to at least one specific second person, each of the at least one specific second person(s) having an associated second electronic device that is trackable via a first electronic device. The method includes receiving a selection of the selectable option and identifying information corresponding to the first electronic device for communicating a delivery trigger to schedule delivery of the item to a first delivery destination. The method includes, in response to subsequently receiving a first delivery trigger from the first electronic device indicating at least one delivery window for delivering the item to the first delivery destination, generating and transmitting a delivery notification to an electronic device of a delivery provider/person, the delivery notification alerting the delivery provider to complete delivery of the item within the provided at least one delivery window, the delivery notification triggering the delivery provider's electronic device to output the notification of the at least one delivery time window for completing the delivery to the first delivery destination.

According to one or more embodiments, the disclosure may include a computer program product that includes a non-transitory computer readable storage device and program code on the computer readable storage device that when executed by a processor associated with an electronic device causes the electronic device to provide functionality of the above-described and additional method processes.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

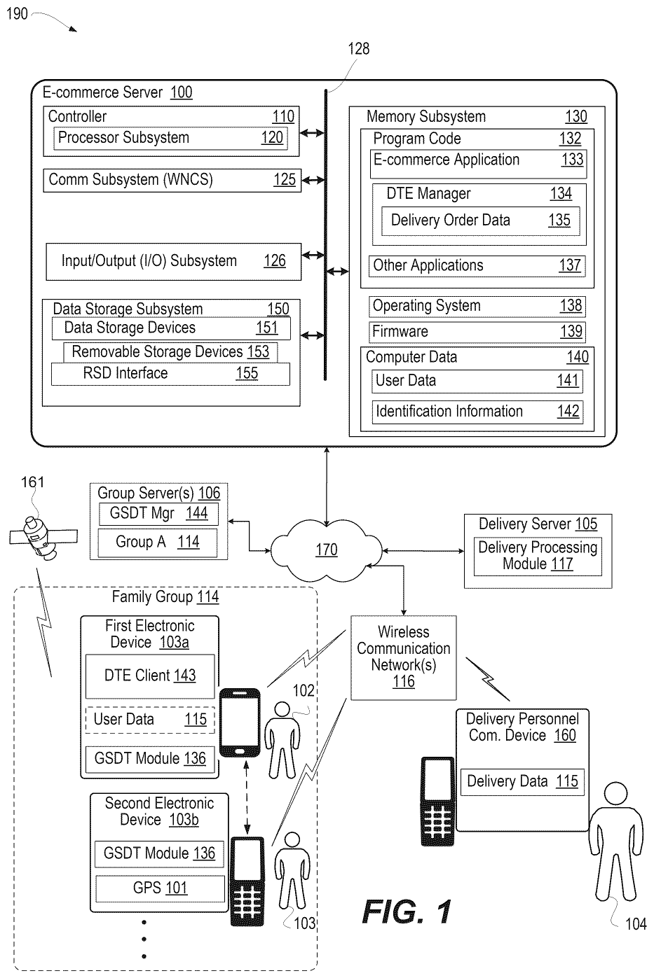

Those of ordinary skill in the art will appreciate that the hardware components and basic configuration depicted in the following figures may vary. For example, the illustrative components within server computing device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

Referring now to the figures and beginning with FIG. 1, there is illustrated an example component makeup of an E-commerce server 100 (i.e., a server computer system within an e-commerce environment), with specific server components that enable the server computer system to implement discreet delivery of online purchases, based on communications with communicatively-connected user devices, according to one or more embodiments. E-commerce server 100 includes specific components that enable the device to facilitate discreet delivery of online purchases, according to one or more embodiments. E-commerce server 100 could be implemented, for example, as server computing system hosting cloud-based retail point of sale for a major retailer. For simplicity, e-commerce server 100 is interchangeably referred to as server 100.

Server 100 includes Controller 110. Controller 110 includes processor subsystem 120, which includes one or more processors, which are not specifically shown. Each processor (typically implemented as a part of a processor integrated circuit (IC) chip), includes processor resources such as central processing unit (CPU), communication signal processing resources such as digital signal processor (DSP), graphics processing unit (GPU), and hardware acceleration (HA) unit. In some embodiments, the hardware acceleration (HA) unit may establish direct memory access (DMA) sessions to route network traffic to various elements within server 100 without direct involvement from a processor or the operating system 138. Controller 110 can interchangeably be referred to as processor (110), the controller being implemented via one or more processers which comprise processor subsystem 120. Collectively, components integrated within processor 110 support computing, classifying, processing, transmitting and receiving of data and information. Processor 110 is communicatively coupled to communications subsystem 125, Input/Output Subsystem 126, Memory Subsystem 130, and data storage subsystem 150, via data bus 128.

Communications subsystem 125 can include wireless network communication subsystem components, which can represent one or more front end devices (not shown) that are each coupled to one or more antennas (not shown). Communications subsystem 125 allows server 100 to communicate via wired connection through a wide area network, such as the Internet, or wirelessly with internal components/devices of a wireless communication network (not shown) via transmissions of communication signals to and from network communication devices, such as base stations or cellular nodes, of wireless communication network. For the purpose of brevity within the present disclosure, all network communications to and from server and among other devices are assumed to be encompassed within network cloud 170.

Server 100 further includes and Input/Output Subsystem 126. I/O subsystem 126 may include devices such as a keyboard, speakers, microphones, disk drives, and a display (not shown).

Server 100 further includes Memory Subsystem (or system memory) 130, which may be a combination of volatile and non-volatile memory, such as random-access memory (RAM) and read-only memory (ROM). System memory 130 can store program instructions/code 132 and corresponding data associated with E-commerce Application 133, delivery time/exclusion determining (DTE) manager 134, other applications 137, an operating system 138, firmware 139, Computer Data 140, including User Data 141 (e.g. tagged delivery metadata), and Identification Information 142 (e.g. unique identifiers, such as phone number, associated with a user device). According to some embodiments, delivery metadata is data corresponding to the purchased item and delivery of the purchased item with the unique ID of the first user device, such as the time a transaction was completed or the time when delivery confirmation was received. Additional applications may also be present. Descriptive names assigned to these executable modules add no functionality and are provided solely to identify the underlying features performed by processing the different modules.

During device operation, processor 110 processes program code of the various applications, modules, OS, and firmware, that are stored in system memory 130. Each module and/or application provides program instructions/code that are processed by processor 110 to cause processor 110 and/or other components of server 100 to perform specific operations, as described herein. For example, delivery time/exclusion determining (DTE) module 152 can include program instructions for implementing server-side features of the disclosed embodiments. DTE module 152 can include instructions that cause or configure processor 110 to provide, within a delivery scheduling user interface, a selectable option providing a first delivery setting that enables a delivery of the item to be scheduled based on receipt of the delivery data from the first user device in order to avoid delivery of the item outside of a specified delivery time or during a delivery exclusion time identified by the received delivery data. The processor 110 is further configured to, in response to receiving a selection of the first delivery setting, activate a dynamic delivery process that configures the computing system to alert the delivery provider of specific restrictions on a time for delivery of the item, which is in part determined based on subsequently received delivery data from the first user device. The processor 110 is further configured to, in response to subsequently receiving delivery data from the first user device indicating at least one of a delivery time window for delivering the purchased item to a delivery destination or a delivery exclusion window during which delivery should not be attempted, generate and transmit a delivery notification to a delivery electronic device belonging to the delivery provider, the notification triggering the delivery electronic device to provide an alert to the delivery provider to complete the delivery of the item based on the received delivery data. The processor 110 receives delivery data 135 from the first user device. Delivery data may include an indication of at least one of a time and a location for completing the delivery of the item.

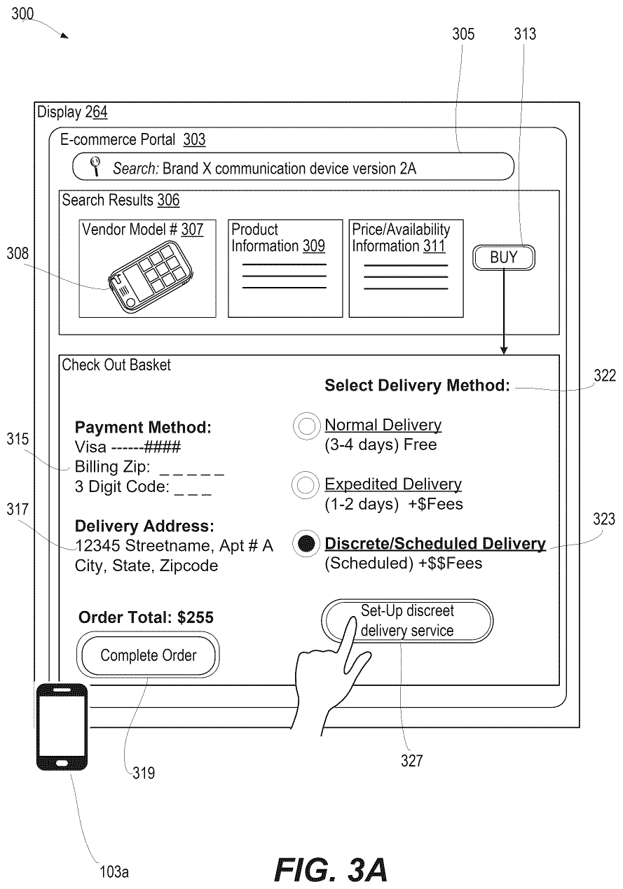

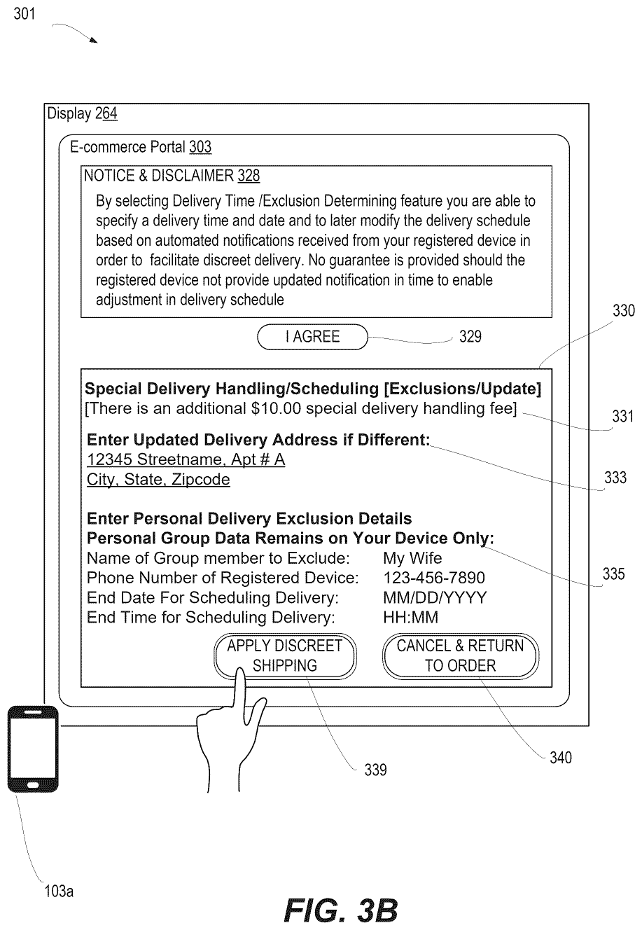

The E-Commerce application 133 can include instructions that cause or configure processor 110 to facilitate the purchase of goods via an on-line marketplace at the direction of the user 102 of the first user device 103a. This process is described in more detail in the description of FIG. 3. The E-commerce server 100 comprises, for example, the website of an online retailor. Server 100 allows first user electronic device 103a to, for example, browse through an inventory catalog, query pricing, perform product searches, make purchases and/or complete related interactions. All such interactions are hereafter referred to as “e-commerce transactions”. E-commerce module 133 within server 100 includes e-commerce information and business logic required for online purchases.

In one or more embodiments, server 100 includes a Data Storage Subsystem 150 which includes Data Storage Devices 151 such as hard disk drives (HDDs), optical disk drives, and/or solid-state drives (SSDs), etc., and a removable storage device 153D) 153, which is inserted into RSD interface 155 that is communicatively coupled via data bus 128 to processor 110. In one or more embodiments, RSD 153 is a non-transitory computer program product or computer readable storage device encoded with program code and corresponding data. RSD 153 may have a version of one or more applications stored thereon. Processor 110 can access RSD 153 to provision processor 110 with program code that, when executed/processed by processor 110, causes or configures processor 110 and/or generally server 100, to provide the various functions described herein.

In addition to the server, the ecommerce environment 190 includes a plurality of user devices arranged or configured to operate within a Family Group 114 consisting of at least a first user device 103a of a first user 102 and a second user device 103b of a second user 104. In one example, the first and second users 102, 104 belong to the same wireless plan or are enrolled in a group application service, provided via group server 106, which is operative to manage the connection between the first and second user devices 103a, 103b. Family group 114 can include additional user devices, as indicated by the trailing dots. As one aspect of the disclosure, each of the devices within family group 114 are able to track the current location of each other device. The location tracking services can be aided or facilitated by GPS satellite 161 providing each device with location data representing the device's present location. However, other location services such as cellular triangulation and WiFi location tracking can be used to determine a current location of each user device.

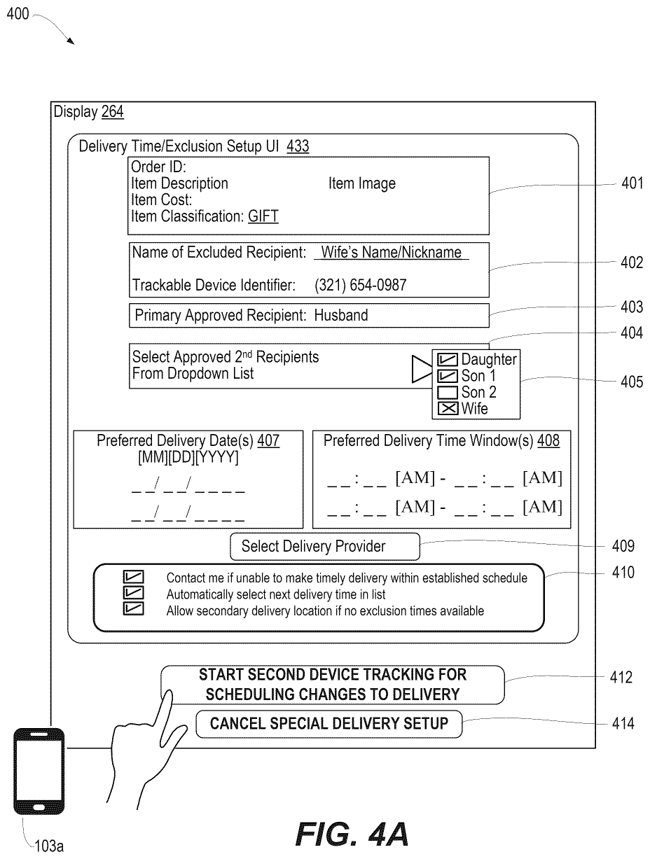

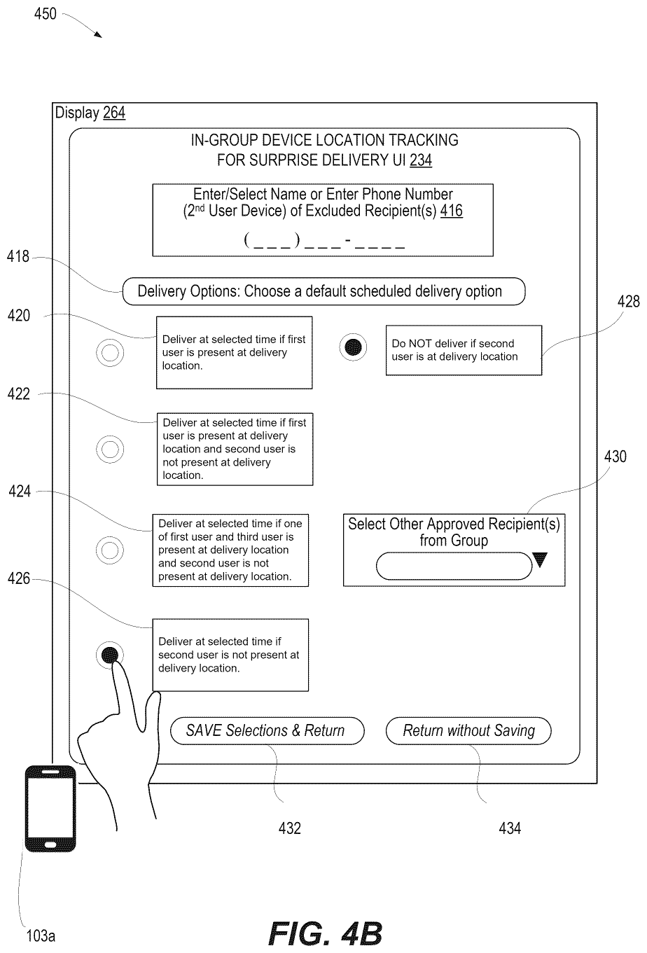

Ecommerce environment 190 also includes a delivery personnel communication device/delivery electronic device 160, which is used by a delivery person 104 and which receives delivery data/instructions from delivery server 105, which is shown separate from e-commerce server 100 and receives delivery instructions from e-commerce server 100. Delivery server 105 may include a Delivery Processing module 117 operative to manage interactions between the delivery personnel device 160 and the first user device 103a and/or the server 100. Delivery personnel device 160 receives delivery information 115 including delivery notifications that may trigger the outputting of delivery instructions that are specific to completing the delivery of the purchased item. Delivery server 105 and e-commerce server 100 can be separate devices communicatively connected to each other through wide area network 170, such as the Internet. Alternatively, in one or more alternate embodiments, the features and functions of delivery server 105 can be provided by a delivery scheduling module provided within e-commerce server 100, as an integrated function of e-commerce server 100. The user devices 103a, 103b and delivery personnel device 160 may be communicatively connected via one or more wireless communication network(s) 116. Group server 106, in managing the Family Group (Group A 114), undertakes operations primarily directed toward tracking the physical location of the at least first and second user devices in conjunction with at least one GPS satellite 161 and GPS modules 101 hosted on the at least two user devices. Group server 106 then makes the location information available to other user devices in the group utilizing the group space device tracking (GSDT) application manager 144 that configures the first electronic device 103a to track a location of the second electronic device 103b or vice versa. First electronic device 103a stores a unique identifier 115 (e.g. the phone number associated with the first electronic device 103a) to facilitate identification of the registered user device during delivery. The unique identifier is subsequently transmitted to the server 100 which forwards it to delivery personnel device 160 where it is stored to facilitate delivery. Moreover, DTE Client Module 143 of first electronic device 103a facilitates operation of DTE Manager 134 of server 100, as described in relation to FIGS. 4A and 4B. A GSDT client module 136 is implemented on each user device. The operations of the above items are described in further detail in the descriptions of the figures that follow.

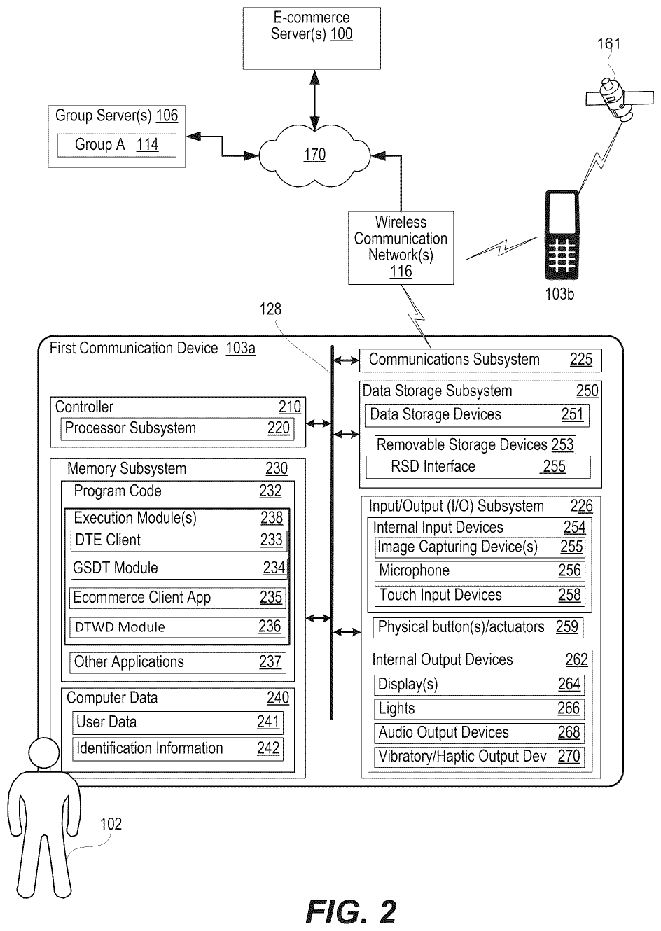

FIG. 2 depicts example component makeup of a first user device 103a operative to implement user device features for discreet delivery of online purchases, according to one or more embodiments. Controller 210, Communication Subsystem 225, and Computer Data 240 of first user device 103a can be substantially similar to Controller 110, Communication Subsystem 125, and Computer Data 140 of server 100 and perform functionality consistent with the description of these elements in relation to FIG. 1. First user device 103a further includes Input/Output (I/O) Subsystem 226.

I/O subsystem 226 includes Integrated Input Devices 254, and Integrated Output Devices 262. Integrated Input Devices 254 can include, but are not limited to, Image Capturing Device(s) 255 such as cameras, Microphone 256, Touch Input Devices 258, and Physical Button(s)/Actuator(s) 259. Integrated Output Devices 262 can include, but are not limited to, Display(s) 264, Lights 266, Audio Output Devices 268 such as speakers, and Vibratory/Haptic Output Device(s) 270.

First user device 103a also includes a Memory Subsystem 230. The Memory Subsystem 230 includes Program Instructions/Code 232 and Computer Data 240. The Program Code 232 includes specific Execution Module(s) 238 that collectively enable or configure processor 210 to cause first user device 103a to perform the various features of the disclosed embodiments. Execution Module(s) 238 include DTE Client 233, Group Space Device Tracking (GSDT) Module 234, E-commerce Client Application 235, and Delivery Time Window Determining (DTWD) Module 236. The Program Code 232 can also include Other Applications 227. It is appreciated that in other/alternate embodiments, two or more of the modules presented within Execution Module(s) 232 may be implemented as a single module. For simplicity, processor execution of instructions from any one of the provided modules can be generally referred to herein as execution of Execution Module 232. The Computer Data 240 includes User Data 241 and Identification Information 242 which are substantially similar to User Data 141 and Identification Information 142 of server 100 and perform functionality consistent with the description of these elements in relation to FIG. 1. Each module and/or application provides program instructions/code that are processed by processor 210 to cause processor 210 and/or other components of user device 103a to perform specific operations, as described herein. For example, delivery time window determining (DTWD) module 236 can include program instructions for implementing features of the disclosed embodiments. DTWD module 236 can include instructions that cause or configure processor 210 to determine at least one of a delivery time window or a delivery exclusion window for when delivery of an item should not be attempted/completed at a delivery destination, the determination being based, in part, on location data of at least the second device 103b determined by execution of the group space device tracking (GSDT) module 234. The processor is further configured to, in response to the second device being away from the destination address for greater than a threshold period of time, generate a delivery time window and communicate the delivery time window to a computer system (e.g., ecommerce server 100 or delivery server 105) associated with a delivery provider to trigger the computer system to schedule delivery of the item based on the delivery time window. The processor is further configured to, in response to the second device being at the destination address and in response to determining, from evaluation of historical data, a likelihood that the item will be received by the second user, generate a delivery exclusion window and communicate the delivery exclusion widow to the computer system to trigger the computer system to withhold/suspend attempts at delivering the items during the delivery exclusion window.

The GSDT Module 234 can include program instructions for implementing features of the disclosed embodiments. GSDT module 234 can include instructions that cause processor 210 to configure the first electronic device 103a to track a location of the second electronic device 103b. The first electronic device 103a is configured to track a location of the second electronic device 103b relative to a destination address, identify when the location of the second device is not at the destination address, and retrieve and evaluate historical location data of the second electronic device 103b to predict a time when the second device will next be at the destination address.

E-commerce client module 235 can include instructions that cause processor 210 to configure the first user device 103a to interact with E-commerce module 133 and first user 102 to perform e-commerce transactions at server 100. Business logic provided by E-commerce module 133 may include, but is not limited to the following: (i) an inventory catalog of at least some of the products offered by E-commerce Server 100, the catalog comprising inventory status indications and estimated delivery times, (ii) pricing information, including special offers and information that varies with time, location, or other parameters, (iii) infrastructure for performing searches such as backend inventory databases and index files for efficient access to databases, (iv) check-out forms and supporting screens, and (v) payment related functions including credit card processing functionality.

As provided, first electronic device 103a is communicatively coupled to second electronic device 103b via wireless communication network 116. Wireless communication network 116 is communicatively coupled to wide area network 170. Group Server 106 is communicatively coupled to wide area network 170. First electronic device 103a and second electronic device 103b receive location data from GPS satellite 161, enabling each device to determine its geographic location and share that location with other devices within family group 114. More specifically, group server 106 receives location information from and stores location information for first electronic device 103a and second electronic device 103b, enabling tracking of the devices within family group 114. The tracking and storage of the device location at group server 106 then allow first electronic device 103a to retrieve location information for second electronic device 103b from group server 106.

FIG. 3A illustrates an exemplary user interface for the first electronic device interacting with e-commerce server during item selection and entry of initial user information required to perform e-commerce transactions, according to one or more embodiments. The server 100 is configured to provide an online shopping interface having a user interface portal 303 for access by the first electronic device 103a to complete a purchase transaction. Effectively, the user (e.g., performing as an online customer) can, via the E-commerce client Application 235, interact with the E-commerce Application 133 and its associated business logic to complete an e-commerce transaction. Here, the first user searches via search field 305 for a communication device (e.g. a smartphone or a tablet). The E-commerce Portal 303 returns search results 306 including an image 308 of the item and vendor model number 307, product details 309, and information on pricing and physical availability 311. If the product is satisfactory, the user may elect to Purchase/Buy by selecting buy option 313. The E-commerce portal 303 then presents a checkout window that includes prompts for the first user to provide information, such as payment information 315 and shipping address 317. The user may then be provided with delivery method selection area 322 presenting options to choose/select a delivery method from among alternative delivery methods, each presenting associated delivery scheduling criteria and costs. The example delivery methods include normal delivery, which is free and can be automatically selected as a default, expedited delivery, which is faster than normal delivery and has an associated fee, and discreet/scheduled delivery 323. As shown by the filled in radio button, the user has selected discreet/scheduled delivery 323. In some embodiments, selection of or hovering over discreet/scheduled delivery can optionally cause the UI to provide the user with an explanatory pop-up notice window 325 explaining details of how the discreet delivery is provided. Also, in the illustrative embodiment, a discreet delivery service button 327 is presented for the user to set-up the parameters for the discreet delivery. Once the shipping method is selected and other details of the order entered, the user may elect to complete checkout for the order by selecting the complete order button 319. Alternatively, prior to completing the order, the user may instead select the discreet delivery service button 327. Selection of the discreet delivery service setup button 327 triggers the opening of a second user interface presented by FIG. 3B.

In one or more embodiments, the controller is further configured to cause the computer system to receive at least one input for completing a purchase transaction for purchasing the item. The controller is configured to cause the computer system to associate the purchase transaction with identification data of the first user, the identification data comprising an ID of the first user device. The controller is configured to cause the computer system to identify that the at least one input for completing the purchase transaction comprises a selection of a discreet delivery option based on communicated input from the first user device. The controller is configured to cause the computer system to, based on the at least one input for completing the purchase transaction comprising the selection of the discreet delivery option: tag the order to be completed by a delivery personnel in a location of the delivery address with special instructions for the delivery personnel to one of: (a) withhold the delivery until at least one delivery time window has been received from the first electronic device and communicated to the delivery personnel, or (b) not schedule to complete the delivery during an exclusion time window provided to the computer system by the first electronic device, the delivery time window and the exclusion time window both being associated with a presence of the second user at the delivery address, the presence being determined by a location of the second user device at the delivery address; transmit a delivery request to the delivery personnel with the special instructions that identify at least one optimal delivery time; and periodically update the at least one optimal delivery time based on receipt of updated location information of at least one of the second user device and the first user device, relative to the delivery address.

FIG. 3B illustrates a second user interface that is rendered and presented on e-commerce portal 303 as a continuation of the initial setup of discreet delivery service, selected in FIG. 3A, according to one or more embodiments. Ecommerce portal 303 presents a notice and disclaimer 328 to the user and the selectable agree option 329 to said notice and disclaimer. User selection of agree option 329 can be a prerequisite to receiving the content of discreet delivery service-side setup (DDSS) window 330, in one or more embodiments. Within DDSS window 330 is a fee notice 331 informing user of the additional fees for requesting discreet delivery service. DDSS window 330 includes address update entry section 333, which prompts the user to update the delivery address, if necessary. It is appreciated that the default address provided at FIG. 3A may not be the address to which the discreet delivery is to occur. DDSS window 330 also presents personal delivery exclusion details section 335 at which the user is prompted to enter personal delivery exclusion details 335 such as the name of the person being excluded from receiving the delivery, the phone number of the registered device (e.g., the first electronic device) that will provide delivery scheduling updates, and an end range for the date and time of delivery (i.e., a final time to attempt delivery). It is appreciated that while the registered device can be described as the first electronic device, the registered device does not need to be the first electronic device. Rather, any suitable device can be used to access the e-commerce server and perform the e-commerce transaction.

According to one or more embodiments, the various information entered within DDSS window 330 becomes the initial delivery scheduling data provided to the e-commerce server 100 and available in the user account securely maintained at the server 100. With the above information entered, DDSS window 330 presents the user with selectable option 339 to proceed with the purchase and apply discreet shipping or option 340 to cancel registration/initial setup for the discreet delivery service and return to the original order (FIG. 3A) on the E-commerce interface/portal 303.

FIG. 4A illustrates an exemplary delivery time/exclusion (DTE) setup user interface (UI) for the first electronic device during provision of initial delivery data for use to provide a first delivery setting for discreet delivery of an online purchase, according to one or more embodiments. As previously described with reference to FIGS. 3A-3B, in electing to have a purchased item delivered using the discreet delivery service, the user, through the DTE client module, accesses, via the communications subsystem, an online-accessible item selection portal, the online-accessible item selection portal being configured to enable selection of an item for delivery as a surprise gift for a particular second person of a group, where a first delivery setting identifies the item for special delivery scheduling that can be automatically modified, as needed, to prevent disclosure of the item to the second person. Local to the first electronic device, an initial setup of the local in-group device tracking for discreet delivery begins with the porting over of order details 401, which includes an Order ID, item description, item cost, and item classification. The item classification is provided by the user who purchased the item. An exclusion entry field 402 provides prompts for entry of a name or nickname and trackable device identifier (e.g., phone number) of the user to be excluded from accepting delivery. These details can be ported over from the E-commerce portal 303, in some embodiments. However, to ensure additional privacy, these details can be provided on the first electronic device directly by entry into exclusion entry window 402. In the example, the user's wife is the excluded recipient, and the primary approved recipient is the husband. Initial setup information to be entered by the user includes recipients approved to receive delivery, preferred delivery dates 407, and preferred delivery time windows 408. Accordingly, DTE setup UI 400 provides second approved recipients field 404 with a selectable option to provide a drop-down selections box 405 showing every member of the family group that can be included or excluded from the discreet delivery. In drop-down selections box 405, both the daughter and first son are selected as approved second recipients, while the wife is deselected or crossed out as a possible recipient. More than one preferred delivery data can be established by the user within preferred delivery dates field 407. Similarly, more than one delivery time window (start time to end time) can be entered by the user within preferred delivery time windows 408.

During setup, the first user may, optionally, select from among delivery providers using provider selection option 409. Additionally, DTE setup UI 400 provides/prompts the user to select one or more mitigation measures 410 for circumstances where delivery as originally planned is not possible. DTE setup UI 400 further includes start option 412, selection of which starts the process of tracking the location of the second device 103b. The activation of this option begins the implementation of the discreet delivery process, whereby location data from the second electronic device 103b is received and monitored by first electronic device 103a, which determines when, or if, to make an adjustment in the delivery time by communicating delivery time updates or triggering data to the E-Commerce Server 100. The user may give permission for another user in the group to receive tracking information for the second electronic device 103b to facilitate acceptance by that device in the case of contingencies. DTE setup UI 400 further includes cancel setup option 414, which the first user 102 may select to abandon setup.

FIG. 4B illustrates an alternate exemplary user interface for the first electronic device 103a to set up discreet delivery using location data of the first electronic device 103a and other electronic devices within the group, according to one or more embodiments. Setup UI 450 for discreet delivery includes the second electronic device identification entry field 416 for entry of the phone number or other unique identifier of the second persons'electronic device. Setup UI 450 includes selectable options for one or more delivery preferences 420, 422, 424, 426, 428. As indicated by the filled in radio button, the user has selected two preferences to apply, namely, (i) Deliver at selected time if second user is not present at delivery location 426 and (ii) do NOT deliver if second user is at delivery location 428. As previously stated, the first user 102 may approve other users from within the group to receive delivery, and similar to drop-down option of FIG. 4A, setup UI 450 presents a field 430 for selection of those approved recipients. As with previous embodiments, first electronic device 103a utilizes the unique device identifier of each second device as the proxy for the corresponding user location. It is appreciated that the delivery preferences listed above are not exhaustive. Once the selection of the delivery preference is made, the user may select save selections and return option 432 or return (to the previous page) without saving option 434.

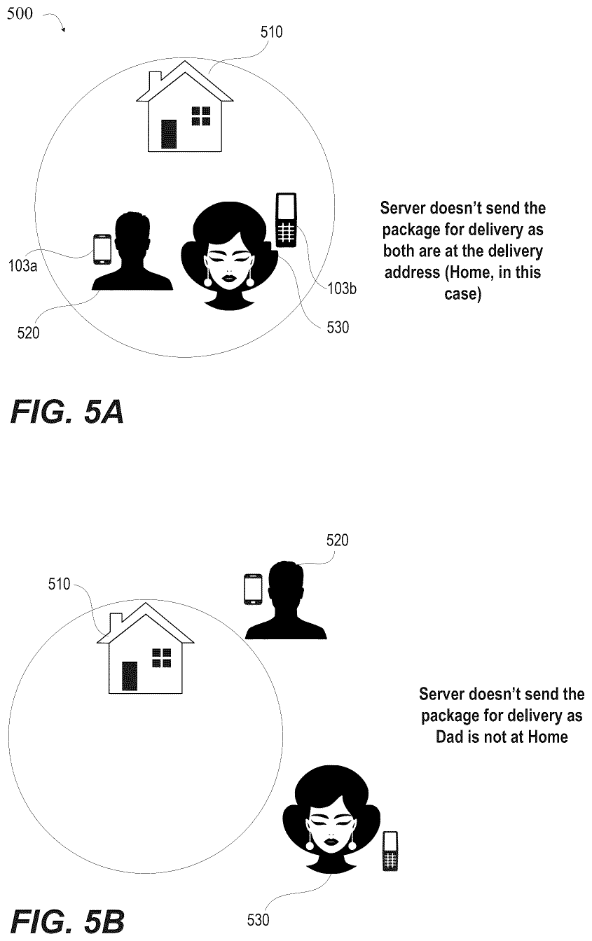

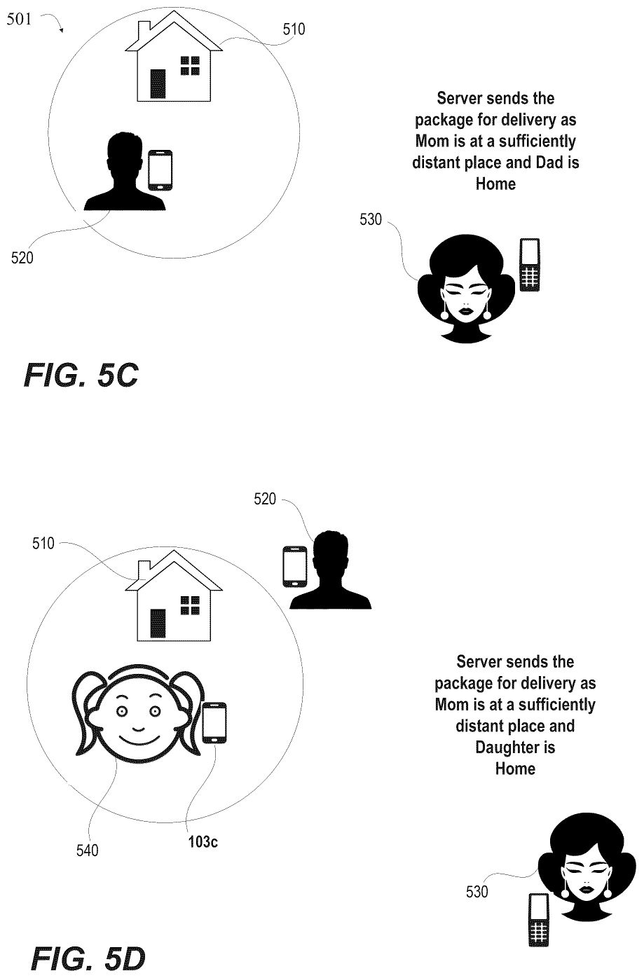

FIGS. 5A-5D depict user devices of a group space and sample arrangements whereby based on the presence or absence of user devices comprising the group, delivery is or is not made, according to one or more embodiments. Both electronic devices 103a, 103b are registered within and/or associated with a family group space (114, FIG. 1). The group space 114 enables tracking by the first electronic device 103a of a current location of each of at least one second electronic device(s) (e.g., 103b), and vice versa. In the illustrative embodiment, the group space is presented as a family space and the at least one second electronic device comprises the second electronic device 103b of the second user 530 and a third user device (103c, FIG. 5D) of a third user 540. The first electronic device 103a is associated with the first user (or husband) 520 and the second electronic device 103b is associated with the second user (or wife) 530. As provided in FIG. 5D, the third electronic device 103c is associated with third user (or daughter) 540. Each electronic device is assumed to be collocated with the corresponding person to whom the device is associated.

Location information for the second electronic device 103b (e.g., GPS coordinates, multi-lateration information) is fed to a dedicated network server that manages the group space. The first electronic device 103a periodically fetches the location of the second electronic device 103b and in effect, the location of the second user (assumed to be collocated with her device) from the dedicated network server. The group space may also include a third device of a third user.

The first user may set conditions for delivery of a package based on preferences regarding the presence or absence of one or more users at the delivery location. For example, if the first user prefers to not deliver if a second user is at the delivery location unless the first user is also there, and a delivery trigger is received from the first electronic device indicating at least one of: (i) at least one of the first device and the third device is located at the delivery destination, while the second device is not located at the delivery destination, (ii) at least one of the first electronic device and the third user device is located at the delivery destination, while the second electronic device is also located at the delivery destination, (iii) only the third device is located at the delivery destination and a third user of the third device has been notified to not reveal receipt of the item to the second user; and (iv) the second electronic device is not located at the delivery destination, delivery will be made for conditions (i), (iii), and (iv). The illustrated examples reflect a first user deliver preference for delivery (at home 510) when either or both of the first and third user (e.g. Dad 520 and Daughter 540, respectively) are at the delivery location and the second user (Mom 530) is sufficiently far away. With the illustrative examples, given the above present conditions, it follows that delivery will be made for FIGS. 5C and 5D but not for FIGS. 5A and 5B.

Thus, in one embodiment the delivery data received by the server computer system 100 from the first electronic device 103a may indicate at least one co-location of group devices from among: at least one of the first electronic device and the third user device is located at the delivery destination, while the second electronic device is not located at the delivery destination (illustrated by FIGS. 5B and/or 5D); at least one of the first electronic device and the third user device is located at the delivery destination, while the second electronic device is also located at the delivery destination; only the third user device is located at the delivery destination and a third user of the third device has been notified to not reveal receipt of the purchased item to the second user (illustrated by FIG. 5D); and the second electronic device is not located at the delivery destination. It is appreciated that many other conditions can be set by the person setting up the discreet delivery given that the group can be significantly larger than three people, each having various different schedules and differing knowledge of the package pickup responsibilities.

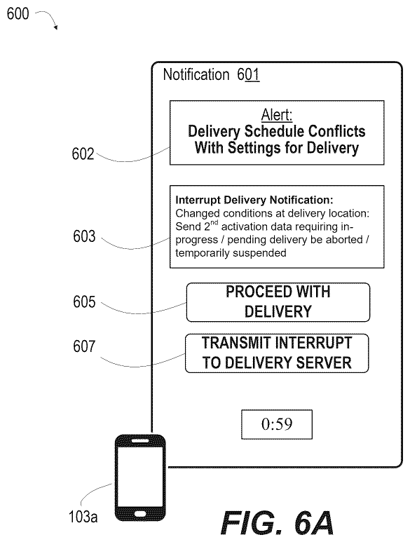

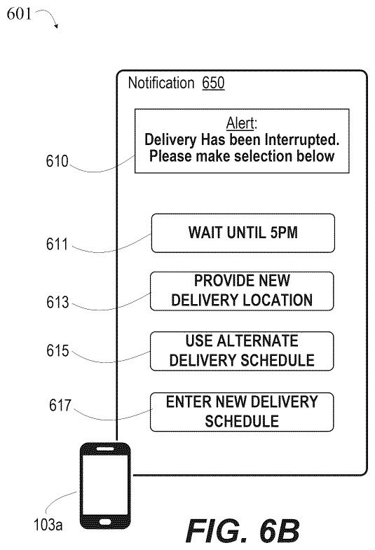

FIGS. 6A and 6B present exemplary user interfaces generated to communicate changes in expected location information for the second electronic device to enable the first electronic device 103a to handle unplanned contingencies whereby discreet delivery cannot be made as previously scheduled. Specifically, FIG. 6A illustrates an exemplary user interface for the first electronic device during the process of updating a delivery schedule due to changed conditions, according to one or more embodiments. In the example embodiment, notification UI 601 is presented on display device of first electronic device 103a. Notification UI 601 includes Alert 602 which is rendered by first electronic device 103a and presented on the display. Notifications UI 601 also presents interrupt delivery notification 603 which explains the condition and presents options for the user to follow. The DTE client module 233 causes the processor of first electronic device 103a to render and present two selectable options, including proceed with delivery option 605 and transmit interrupt to delivery server option 607. To enable automation of the delivery adjustment and trigger adjustments in instances where the device user is not able to access his device, DTE client module incorporates a timer 609, which presents a count down of a pre-established maximum response time for the device user to make a selection on how to respond to the detected, unexpected changed in the location of the second electronic device 103b towards or within the delivery location. In the illustrative embodiment, timer 609 presents a countdown of 60 seconds. Thus, according to the presented example, upon receiving alert 602 and notification 603 indicating that delivery cannot be made as originally scheduled, the first user has 1 minute to choose to either proceed with delivery despite altered conditions (option 605) or to transmit an interrupt to the delivery server (option 607).

FIG. 6B provides an exemplary second user interface for the first electronic device 103a during the process of implementing the updated delivery schedule of FIG. 6A, according to one or more embodiments. In response to the user electing to send an interrupt to the delivery server in Notification UI 601, the user is provided with Interrupt user interface (UI) 650, which includes Alert 610 prompting the user to choose from among various options presented for mitigation. Example Interrupt UI 650 presents delay option 611 which delays the delivery until a specific time (e.g., 5:00 p.m.), new delivery location option 613, which provides a new delivery location (e.g., the neighbor's house), use provided alternate schedule option 615, using one of a number of previously submitted alternative delivery days and/or times, or enter new schedule option 617, which enables the user to enter an entirely new delivery schedule for the order. Each of these options can trigger opening of a secondary window to allow the user to provide/enter the required data for the selected option.

While the above description details the transmission of instructions from the first electronic device 103a to the E-commerce server 100 or the delivery server 105, during the process of updating a delivery schedule due to changed conditions, in one or more embodiments the first electronic device 103a may instead send instructions directly to the delivery electronic device 160. For example, upon being notified that the delivery electronic device 160 is in the neighborhood that includes the delivery location, if the first user 102 realizes that the intended recipient is at the delivery location or likely to return soon, he may send an interrupt directly to the delivery electronic device 160 followed by instructions to pause delivery, delay delivery for a specified time, or deliver to a different address. One or more of these processes may be dynamically completed by the electronic device 103a being preconfigured to trigger changes in the delivery schedule with direct communication to the delivery person's communication device, delivery electronic device 160, where the contact details, e.g., phone number of the delivery electronic device 160, has been provided to the electronic device 103a, which also receives current, real-time updates of the location of the delivery electronic device 160 during final stages of delivery of the acquired item.

According to one aspect of the disclosure, although mitigation measures may be ordered by the first electronic device 103a transmitting delivery related data to the e-commerce server 100 or delivery server 105, as provided in the above descriptions of FIGS. 6A and 6B, the changes to the delivery schedule can be carried out at or by direction of the E-commerce server 100 as the overarching controlling device. With respect to the handling of unexpected contingencies that can affect the scheduled discreet delivery, after the initial setup of the discreet delivery process, as depicted in FIG. 3B and FIGS. 4A and 4B, the disclosure provides a dynamic delivery process that configures the computing system to alert the delivery provider of specific restrictions that can arise and/or affect a time for delivery of the item, in part determined based on subsequently received delivery data from the first electronic device. Delivery notifications may be transmitted to the electronic device 160 of the delivery personnel to trigger the outputting of delivery instructions that are specific to completing the delivery of the purchased item based on the received delivery data.

In some embodiments, the E-commerce server may: receive, as the delivery data from the first electronic device, first delivery activation data corresponding to a location of the second electronic device being away from the delivery destination during at least one delivery window; and monitor for subsequent receipt of at least one of: (i) a confirmation of completion of the delivery of the item within the delivery window, the confirmation received from at least one of the delivery electronic device 160 and the at least one first electronic device; and (ii)second delivery data comprising an interrupt delivery notification from the first electronic device indicating that delivery conditions have changed, requiring an in-progress or pending delivery to be aborted or temporarily suspended. In particular embodiments, the E-commerce server may: in response to receiving the interrupt delivery notification from the first electronic device may, generate and transmit an interrupt notification to the electronic device 160 of the delivery provider/personnel alerting the delivery provider to abort/suspend completion of the delivery until additional information is provided with a new time window for completing the delivery. In particular embodiments, the E-commerce server 100 may: in response to receiving the interrupt delivery notification from the second electronic device 103b, identify a next delivery window and adjust a delivery time window notification to the delivery electronic device 160 to trigger completion of the delivery during the identified next delivery window. In particular embodiments, the E-commerce server may: in response to receiving the interrupt delivery notification from the first electronic device, receive, as the delivery data from the first electronic device, second delivery activation data corresponding to a location of one of the at least one first electronic device being at the delivery destination concurrently with the second electronic device being away from the delivery destination; and generate and transmit the at least one delivery window to the electronic device of the delivery provider, based on receiving the second delivery activation data.

In particular embodiments, the E-commerce server may: receive, as the delivery data from the first electronic device 103a, third delivery activation data corresponding to a location of one of the at least one first electronic device being at the delivery destination concurrently with the second device 103b; based on receiving the third delivery activation data, generate and transmit the at least one delivery window, along with specific instructions identifying which user to provide the item to at the delivery destination; track a location of a mobile electronic device 160 of a delivery personnel; and in response to an indication that the delivery personnel has initiated a delivery of the purchase item to the delivery destination, transmit, to the at least one first electronic device, a delivery alert and real time updates of the location of the mobile electronic device until receipt of a confirmation of completion of the delivery.

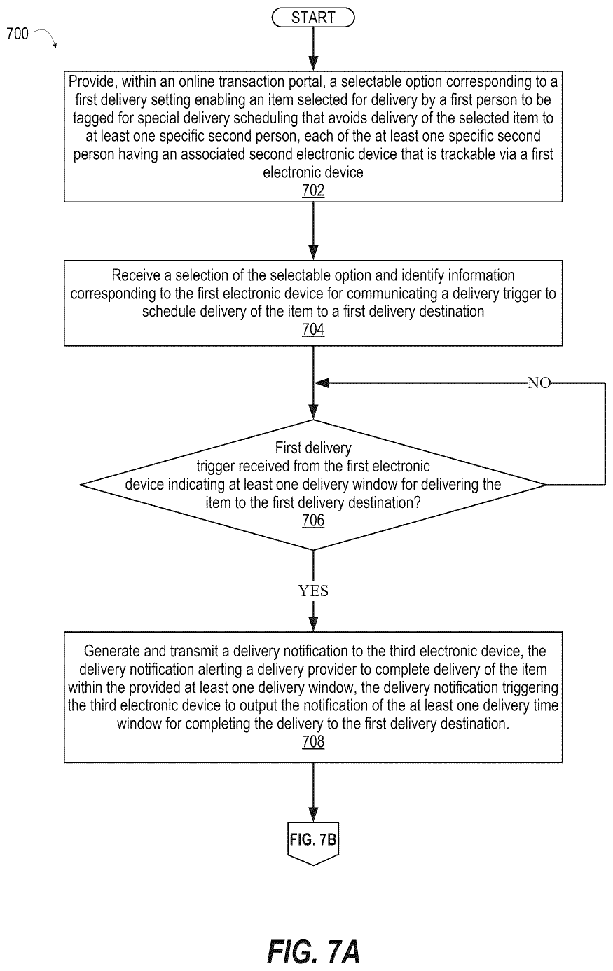

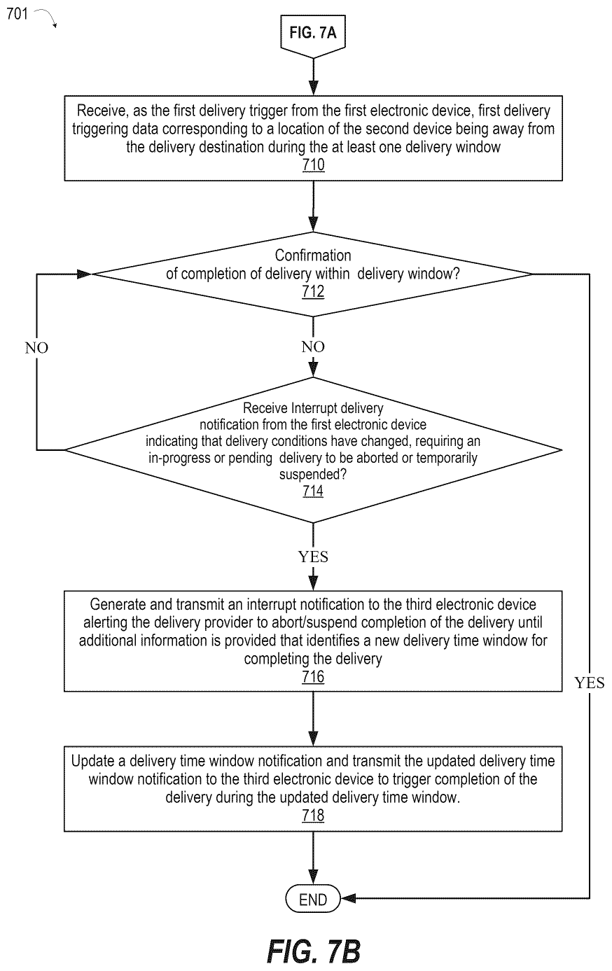

Referring now to the flowchart presented by FIGS. 7A-7B, the description of the method in FIGS. 7A-7B is provided with general reference to the specific components and features illustrated within the preceding FIG. 1. Specific components referenced in the methods of FIG. 7A-7B may be identical or similar to components of the same name used in describing preceding FIG. 1. In one or more embodiments, processor 110 (FIG. 1) is configured to cause E-Commerce Server 100 (FIG. 1) to provide the described functionality of the methods of FIG. 7A-7B by executing program code for one or more modules or applications provided within device memory 130 of E-Commerce Server 100, including E-Commerce Application 133 and DTE Manager 134 (FIG. 1).

FIGS. 7A-7B (collectively FIG. 7) depict a flowchart of a computer-implemented method 700 performed by processor 110 of a server computing system for discreet delivery of online purchases, according to one or more embodiments. The method 700 starts at block 702 where the e-commerce server provides, within an online transaction portal, a selectable option corresponding to a first delivery setting enabling an item selected for discreet delivery by a first user to be tagged for discreet delivery scheduling that avoids delivery of the selected item to at least one specific second user. According to the described embodiments, each of the at least one specific second user has an associated second electronic device that is location-trackable via a first electronic device of the first user. The user devices can all be associated within a device grouping, such as a family group, whereby each device can track and/or received real-time information about a current location of the other device. The method continues to block 704, where the e-commerce sever receives a selection of the selectable option and identifies information corresponding to the first electronic device for communicating a delivery trigger to schedule delivery of the item to a first delivery destination. The method then continues to block 706 where a determination is made as to whether the e-commerce server has subsequently received a first delivery trigger from the first electronic device indicating at least one delivery window for delivering the item to the first delivery destination. If the trigger has been received, the method proceeds to block 708, where the e-commerce server generates and transmits a delivery notification to an electronic device of a delivery provider. The delivery notification triggers the delivery electronic device to output the notification of at least one delivery time window for completing the discreet delivery to the first delivery destination and alerts a delivery provider to complete delivery of the item within the provided at least one delivery window. The method then proceeds to FIG. 7B.

At FIG. 7B, the method 700 continues to block 710, where the e-commerce server receives, as the first delivery trigger from the first electronic device, first delivery triggering data corresponding to a location of the second device being away from the delivery destination during the at least one delivery window. The method then proceeds to block 712, where a determination is made as to whether the e-commerce server receives a confirmation of completion of the delivery within one of the at least one delivery window, the confirmation being received from at least one of the delivery personnel's electronic device and the first electronic device. If delivery is confirmed, the method ends. If delivery is not confirmed, the method proceeds to block 714, where a determination is made as to whether the e-commerce server receives an interrupt delivery notification from the first electronic device indicating that delivery conditions have changed, requiring an in-progress or pending delivery to be aborted or temporarily suspended. If a delivery interrupt notification is received, the method proceeds to block 716, where the E-commerce server generates and transmits an interrupt notification to the electronic device of the delivery provider alerting the delivery provider or delivery personnel to abort/suspend completion of the delivery until additional information is provided that identifies a new delivery time window for completing the delivery. The method then proceeds to block 718, where the e-commerce server updates a delivery time window notification and transmits the updated delivery time window notification to the electronic device of the delivery personnel to trigger completion of the delivery during the updated delivery time window. Then, the method ends.

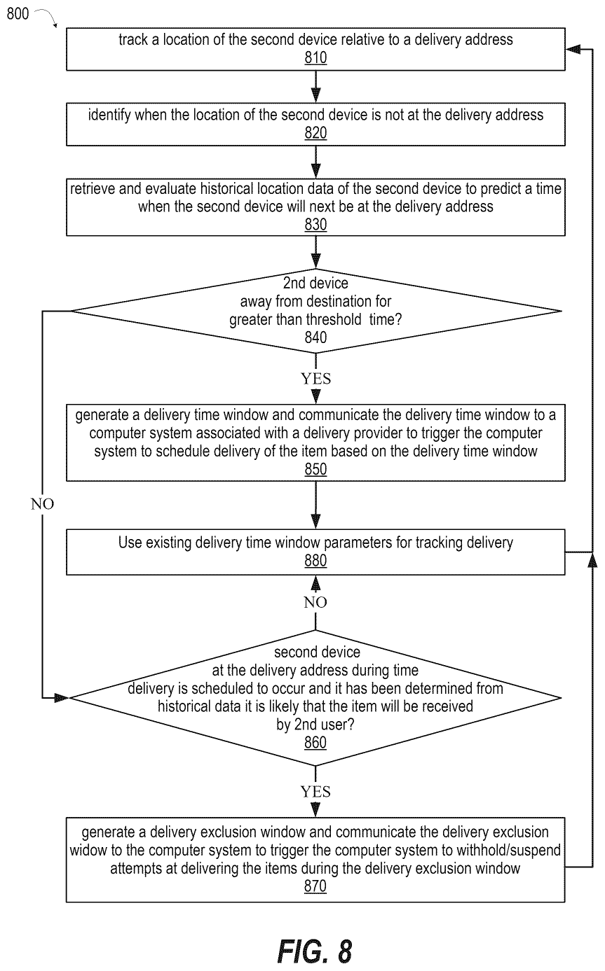

Referring now to the flowchart presented by FIG. 8, the description of the method in FIG. 8 is provided with general reference to the specific components and features illustrated within the preceding FIG. 2. Specific components referenced in the method of FIG. 8 may be identical or similar to components of the same name used in describing preceding FIG. 2. In one or more embodiments, processor 210 (FIG. 2) first electronic device 103a (FIG. 2) to provide the described functionality of the methods of FIG. 8 by executing program code for one or more modules or applications provided within device memory 230 of first electronic device 103a, including GSDT Module 234 and DTWD Module 236 (FIG. 2).

FIG. 8 depicts a flowchart of another computer-implemented method for user-device support of discreet delivery of online purchases. This flowchart describes a process from the perspective of the first user device 103a implementing processes that can involve features of the user interfaces of FIGS. 4A-4B and 6, with device components as illustrated by FIG. 2, within a group environment as presented at FIG. 1. The method begins at block 810, where the first user device tracks a location of the second device relative to a delivery address. The method continues to block 820, where the first user device identifies when the location of the second device is not at the delivery address. The method continues to block 830, where the first user device retrieves and evaluates historical location data of the second device to predict a time when the second device will next be at the delivery address. The method continues to block 840, where a determination is made as to whether the second device is away from the delivery address and is expected/predicted to be away from the delivery address for greater than a threshold period of time. If the determination is affirmative, the method proceeds to block 850, where the first user device generates a delivery time window and communicates the delivery time window to a computer system associated with at least one of an e-commerce system and a delivery provider to trigger the computer system to schedule delivery of the item based on the delivery time window. Method transitions to block 880 where the first electronic device utilizes the delivery time window parameters in tracking the delivery. If the second device is not expected to be away from the delivery address for greater than a threshold period of time, the method proceeds to block 860 where a next determination is made as to whether the second device is at or is predicted to be at the destination address during the time in which the delivery is scheduled to occur, where there is a reasonable likelihood that the item will be received by the second person. In one or more embodiments, this determination can be based on an evaluation of historical data from prior deliveries to the delivery location when the second user was present. If the determination is affirmative, the method proceeds to block 870, where the first user device generates a delivery exclusion window and communicates the delivery exclusion widow to the computer system to trigger the computer system to withhold/suspend attempts at delivering the items during the delivery exclusion window. If the determination is negative, the method transitions to block 880. From block 880, the method returns to block 810, and the process of tracking the location of the second device and making any needed adjustments to the delivery time window continues until delivery of the item is completed.

Accordingly, by implementing the above-described processes, a user of a device completing an electronic transaction for surprise delivery to a delivery location is able to maintain the surprise from a selected one or more persons who may have an association with the delivery location. Discreet delivery is enabled by using a changeable delivery schedule that takes into account the anticipated and tracked (real-time) presence or absence of relevant persons at the delivery site. Delivery schemes must take into account the location of persons who the customer does not want to access or be made aware of the delivered goods. The location of persons to be prevented from accepting delivery and the occurrence of events that negatively impact delivery times are monitored, and the delivery windows are adjusted and communicated to the delivery personnel in order to achieve successfully discreet delivery. The described methods thus provide an improvement in existing technology for delivery of purchased items to be completed without delivery occurring to someone not intended to receive the delivered item.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regards to the sequence of operations without departing from the spirit or scope of the present innovation. Use of a particular sequence is therefore, not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the innovation. The described embodiments were chosen and described in order to best explain the principles of the disclosure and their practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. A computer system comprising:
a communications subsystem that communicatively couples the computer system to (i) at least one first electronic device that monitors location data of at least one second electronic device, the at least one first and at least one second electronic devices being communicatively connected within a device-connected group, the at least one second electronic device comprising a second user device associated with a second user and (ii) at least one delivery electronic device associated with a delivery provider;
a memory comprising a delivery time/exclusion determining (DTE) module that identifies and indicates, for use by a delivery provider, at least one of a preferred delivery time window and a delivery exclusion window corresponding to when delivery of an item should or should not be attempted at a delivery address, in part based on a corresponding one of delivery time and delivery exclusion data received at the computer system from a first user device among the at least one first device, the first user device being linked with discreet delivery of the item and configured to track a known or expected location of the second user device and transmit the delivery data based on a known or expected location of the second user device; and
a controller communicatively coupled to the communications subsystem and the memory and which executes the DTE module, wherein the controller is configured to cause the computer system to:
provide, within a delivery scheduling user interface, a selectable option providing a first delivery setting that enables discreet delivery of the item to be scheduled based on receipt of the delivery data from the first user device in order to avoid delivery of the item outside of a specified delivery time or during a delivery exclusion time identified by the received delivery data; and
in response to receiving a selection of the first delivery setting, activating a dynamic delivery process that configures the computing system to alert the delivery provider of specific restrictions on a time for delivery of the item, which is in part determined based on subsequently received delivery data from the first user device; and
in response to subsequently receiving delivery data from the first user device indicating at least one of a delivery time window for delivering an acquired item to a delivery destination or a delivery exclusion window during which delivery should not be attempted, generate and transmit a delivery notification to the delivery electronic device, the notification triggering the delivery electronic device to provide an alert to the delivery provider to complete the delivery of the item based on the received delivery data.

2. The computer system of claim 1, wherein the delivery data comprises an indication of at least one of a time and a location for completing the delivery of the item.

3. The computer system of claim 1, wherein the acquired item is a purchased item from a retailer, and the controller is configured to cause the computer system to:
receive selection of the item during a purchase transaction;
receive at least one unique device identifier (ID) associated with the first user device;
associate stored delivery metadata corresponding to the purchase transaction and discreet delivery of the purchased item with the unique ID of the first user device;
monitor for received delivery data from the first user device, the received delivery data having metadata with the unique ID that indicates origination from the first user device associated with the purchase transaction and delivery of the purchased item; and
apply the received delivery data to generate a corresponding delivery notification that is transmitted to the delivery provider.

4. The computer system of claim 3, wherein the delivery notification triggers the delivery electronic device to output delivery instructions that are specific to completing the delivery of the purchased item based on the received delivery data.

5. The computer system of claim 1, wherein the controller is configured to cause the computer system to:
receive, as the delivery data from the first user device, first delivery activation data corresponding to a location of the second user device being away from the delivery destination during at least one delivery window; and
monitor for subsequent receipt of at least one of:
a confirmation of completion of the delivery of the item within the delivery window, the confirmation received from at least one of the delivery electronic device and the at least one first electronic device; and
second delivery data comprising an interrupt delivery notification from the first electronic device indicating that delivery conditions have changed, requiring an in-progress or pending delivery to be aborted or temporarily suspended.

6. The computer system of claim 5, wherein the controller is configured to cause the computer system to:
in response to receiving the interrupt delivery notification from the first electronic device:
generate and transmit an interrupt notification to the delivery electronic device alerting the delivery provider to abort/suspend completion of the delivery until additional information is provided with a new time window for completing the delivery.

7. The computer system of claim 6, wherein the controller is further configured to identify a next delivery window and adjusts a delivery time window notification to the delivery electronic device to trigger completion of the delivery during the identified next delivery window.

8. The computer system of claim 1, wherein the controller is configured to cause the computer system to:
receive, as the delivery data from the first user device, second delivery activation data corresponding to a location of one of the at least one first electronic device being at the delivery destination concurrently with the second user device being away from the delivery destination; and
generate and transmit the at least one delivery window to the delivery electronic device, based on receiving the second delivery activation data.

9. The computer system of claim 1, wherein the controller is configured to cause the computer system to:
receive, as the delivery data from the first user device, third delivery activation data corresponding to a location of one of the at least one first electronic device being at the delivery destination concurrently with the second device;
based on receiving the third delivery activation data, generate and transmit the at least one delivery window, along with specific instructions identifying which user to provide the item to at the delivery destination;
track a location of a mobile electronic device of a delivery personnel; and
in response to an indication that the delivery personnel has initiated a delivery of the purchase item to the delivery destination, transmit, to the at least one first electronic device, a delivery alert and real time updates of the location of the mobile electronic device until receipt of a confirmation of completion of the delivery.

10. The computer system of claim 1, wherein the at least one first electronic device and the at least one second electronic device are associated within a group space that enables tracking by each of the at least one second electronic device of a current location of each of the at least one second electronic device.

11. The computer system of claim 10, wherein:
the group space is a family space and the at least one second electronic device comprises the second user device of the second user and a third user device of a third user; and
the delivery data received from the first user device indicate at least one co-location of group devices from among a set comprising:
at least one of the first user device and the third user device is located at the delivery destination, while the second user device is not located at a delivery destination;
at least one of the first user device and the third user device is located at a delivery destination, while the second user device is also located at the delivery destination;
only the third user device is located at the delivery destination and a third user of the third device has been notified to not reveal receipt of the purchased item to the second user; and
the second user device is not located at the delivery destination.

12. The computer system of claim 1, wherein the controller is configured to cause the computer system to:
schedule an initial delivery phase of the delivery, based on a first general location parameter for delivering the item from a remote origination point to a local delivery location from which localized delivery by the delivery provider can be completed within a specific delivery time window.

13. The computer system of claim 1, configured to provide an online shopping interface having a user interface portal for access by the first user device to complete a purchase transaction, wherein the controller is further configured to cause the computer system to:
receive at least one input for completing a purchase transaction for purchasing the item;
associate the purchase transaction with identification data of a first user, the identification data comprising an ID of the first user device;
identify that the at least one input for completing the purchase transaction comprises a selection of a discreet delivery option based on communicated input from the first user device; and
based on the at least one input for completing the purchase transaction comprising the selection of the discreet delivery option:
tag the order to be completed by a delivery personnel in a location of the delivery address with special instructions for the delivery personnel to one of: (a) withhold the delivery until at least one delivery time window has been received from the first electronic device and communicated to the delivery personnel; or (b) not schedule to complete the delivery during an exclusion time window provided to the computer system by the first electronic device, the delivery time window and the exclusion time window both associated with a presence of the second user at the delivery address, the presence determined by a location of the second user device at the delivery address;
transmit a delivery request to the delivery personnel with the special instructions that identify at least one optimal delivery time; and
periodically update the at least one optimal delivery time based on receipt of updated location information of at least one of the second user device and the first user device, relative to the delivery address.

14. A method comprising:
providing, within an online transaction portal, a selectable option corresponding to a first delivery setting enabling an item selected for discreet delivery by a first user to be tagged for discreet delivery scheduling that avoids delivery of the selected item to at least one specific second user, each of the at least one specific second user having an associated second electronic device that is location-trackable via a first electronic device of the first user;
receiving a selection of the selectable option and identifying information corresponding to the first electronic device for communicating a delivery trigger to schedule delivery of the item to a first delivery destination;
in response to subsequently receiving a first delivery trigger from the first electronic device indicating at least one delivery window for delivering the item to the first delivery destination, generating and transmitting a delivery notification to a delivery electronic device of a delivery provider, the delivery notification triggering the delivery electronic device to output the notification of at least one delivery time window for completing the discreet delivery to the first delivery destination and alerting a delivery provider to complete delivery of the item within the provided at least one delivery window.

15. The method of claim 14, further comprising:
receiving, as the first delivery trigger from the first electronic device, first delivery triggering data corresponding to a location of the second device being away from the delivery destination during the at least one delivery window; and
monitoring for subsequent receipt of at least one of:
a confirmation of completion of the delivery within one of the at least one delivery window, the confirmation received from at least one of the delivery electronic device and the first electronic device; and
an interrupt delivery notification from the first electronic device indicating that delivery conditions have changed, requiring an in-progress or pending delivery to be aborted or temporarily suspended.

16. The method of claim 15, further comprising:
in response to receiving the interrupt delivery notification from the first electronic device, generating and transmitting an interrupt notification to the delivery electronic device alerting the delivery provider to abort/suspend completion of the delivery until additional information is provided that identifies a new delivery time window for completing the delivery; and
in response to receiving the additional information with the new delivery time window, updating a delivery time window notification and transmitting the updated delivery time window notification to the delivery electronic device to trigger completion of the delivery during the updated delivery time window.

17. The method of claim 14, further comprising:
receiving, as the delivery trigger from the at least one first electronic device, at least one of:
a second delivery triggering data corresponding to a location of the first device being at the delivery destination concurrently with the second device being away from the delivery destination, wherein in response to receiving the second delivery triggering data, the method comprises generating and transmitting the at least one delivery window based on receiving the second delivery triggering data; and
a third delivery triggering data corresponding to a location of the first device being at the delivery destination concurrently with the second device, wherein in response to receiving the third delivery triggering data, the method comprises: generating and transmitting the at least one delivery window, along with specific instructions identifying which user to provide a purchased item to at the delivery destination; tracking a location of the delivery electronic device of delivery personnel; and in response to an indication that the delivery personnel has initiated a delivery of the purchase item to a delivery address, transmitting, to the at least one first electronic device, a delivery alert and real time updates of the location of the delivery electronic device until receipt of a completion confirmation of the delivery.

18. The method of claim 14, wherein:
the first electronic device and the second electronic device are associated within a group space that enables tracking by the first electronic device of a current location of the second electronic device;
the group space comprises a third device of a third user; and
the delivery trigger received from the first electronic device indicates at least one of:
at least one of the first device and the third device is located at the delivery destination, while the second device is not located at the delivery destination;
at least one of the first user device and the third user device is located at the delivery destination, while the second user device is also located at the delivery destination;
only the third device is located at the delivery destination and a third user of the third device has been notified to not reveal receipt of the item to the second user; and
the second user device is not located at the delivery destination.

19. A computer program product comprising: a non-transitory computer readable storage device; and program code on the computer readable storage device that when executed by a processor associated with a computer system, the program code configures the computer system to provide functionality of claim 14.

20. An electronic device comprising:
a communications subsystem that communicatively connects the electronic device to at least one second electronic device within a group of electronic devices and to at least one delivery electronic device of an item supplier or a delivery provider, the at least one second electronic device comprising a second device of a second user whose location can be tracked by the electronic device;
a memory comprising: execution modules that configure the electronic device to track a location of the second device and configures the electronic device to determine at least one of a delivery time window for completing a delivery of an item or a delivery exclusion window for when delivery of the item should not be attempted/completed at a delivery destination, the determination based, in part, on location data of at least the second device determined by the electronic device relative to the delivery destination; and
a controller communicatively coupled to the communications subsystem and the memory and which executes the execution modules, wherein the controller is configured to cause the electronic device to:
enable access, via the communications subsystem, to an online-accessible item selection portal, the online-accessible item selection portal configured to enable selection of the item for discreet delivery as a surprise gift for the second user, wherein a first delivery setting identifies the item for discreet delivery scheduling that avoids disclosure of the item to the second user;
following completion of selection of the item for delivery via discreet delivery scheduling, initiating a dynamic discreet delivery process that configures the electronic device to transmit an alert/message to a computer of at least one of the item supplier and the delivery provider with specific limitations on a time window for delivery of the item, which is in part determined based on the location of at least the second device relative to the delivery destination;
track a location of the second device relative to the destination address;
identify when the location of the second device is not at and predicted to not be at the destination address;
retrieve and evaluate historical location data of the second device to predict a time when the second device will next be at the destination address;
in response to the second device being away from or expected to be away from the destination address for greater than a threshold period of time, generate a delivery time window and communicate the delivery time window to the computer system associated with the item supplier or delivery provider to trigger the computer system to schedule deliver of the item based on the delivery time window; and
in response to the second device being at or predicted to be at the destination address during a previously provided delivery time window and determining, from evaluation of historical data, a likelihood that the item will be received by the second user, generate a delivery exclusion window and communicate the delivery exclusion widow to the computer system to trigger the computer system to withhold/suspend attempts at delivering the items during the delivery exclusion window.
